(19) United States
(12) Patent Application Publication
(10) Pub. No.: US 2004/0169873 A1
(43) Pub. Date: Sep. 2, 2004

(54) Automatic determination of custom parameters based on scanned image data

(75) Inventor: Ramesh Nagarajan, Pittsford, NY (US)

Correspondence Address: Patrick R. Roche, Esq., Fay, Sharpe, Fagan, Minnich & McKee, LLP, Seventh Floor, 1100 Superior Avenue, Cleveland, OH, 44114-2579, US

(73) Assignee: Xerox Corporation

(21) Appl. No.: 10/377,047

(22) Filed: Feb. 28, 2003

(51) Int. Cl. H04N 1/40; H04N 1/407; H04N 1/58; H04N 1/04; H04N 1/48

(52) U.S. Cl. 358/1.9; 382/319; 382/282; 358/474; 358/504; 358/505; 358/406

(57) ABSTRACT

A method and system for image scanning presents a user with a suggested parameter adjustment to a scanned image upon system analysis of corresponding scanned image data. A scanner generates initial preview image data of the scanned image. A display displays the image to the user from the initial preview image data. A processor detects a selected portion of the preview image data as having a likelihood of being a standard parameter and for determining a suggested adjustment to the initial preview image data for displaying the selected portion as the standard parameter within the displayed image. The suggested adjustment is communicated to the user and the user implements or overrides the suggested adjustment in a subsequent scan of the image, whereby the user may obtain desired image data for the subsequent scan and the suggested adjustment.

### FIELD OF THE INVENTION

The present invention relates to a digital scanner for scanning images. More specifically, the present invention is directed to a method and apparatus for scanning a color document and for processing the corresponding digital data to provide suggested adjustments for improving the image as stored in memory, which adjustments can be selectively accepted by a user and then adopted in a subsequent scan of the image. The present invention provides for determining more accurate scanned image data based upon system analysis and user supervisory approval.

### BACKGROUND OF THE INVENTION

In a conventional digital scanner, a light source is used to illuminate a document comprising the image to be scanned. The conventional digital scanner also includes a platen glass upon which the document rests and a platen cover. The light emitted by the light source illuminates the document and is reflected off and imaged by an optical system or lens system towards either a CCD sensor array or full width array, which converts the reflected light into electrical signals which are eventually converted into digital image data. An image processing circuit electronically registers the image, and converts the electrical signals into digital image data so that the digital image data can be utilized by an image output terminal, network citizen, or memory device.

In the prior art, a printer or other digital imaging system is typically coupled to a digital scanner for scanning an original image (e.g. document) and employs an initial step of charging a photoconductive member (photoreceptor) to a substantially uniform potential. The charged surface of the photoconductive member is thereafter exposed to a light image of an original document to selectively dissipate the charge thereon in selected areas irradiated by the light image. This procedure records an electrostatic latent image on the photoconductive member corresponding to the informational areas contained within the original document being reproduced. The latent image is then developed by bringing a developer including toner particles adhering triboelectrically to carrier granules into contact with the latent image. The toner particles are attracted away from the carrier granules to the latent image, forming a toner image on the photoconductive member, which is subsequently transferred to a copy sheet. The copy sheet having the toner image thereon is then advanced to a fusing station for permanently affixing the toner image to the copy sheet. Such a process is generally identified as xerographic copying or printing.

The approach utilized for multicolor electrostatographic printing is substantially identical to the process described above. However, rather than forming a single latent image on the photoconductive surface in order to reproduce an original document, as in the case of black and white printing, multiple latent images corresponding to color separations are sequentially recorded on the photoconductive surface. Each single color electrostatic latent image is developed with toner of a color complimentary thereto and the process is repeated for differently colored images with the respective toner of complimentary color. Thereafter, each single color toner image can be transferred to the copy sheet in superimposed registration with the prior toner image, creating a multi-layered toner image on the copy sheet. Finally, this multi-layered toner is permanently affixed to the copy sheet in substantially conventional manner to form a finished copy.

In today's business and scientific world, color has become essential as a component of communication. Color facilitates the sharing of knowledge and ideas. Companies involved in the development of digital color print engines are continuously looking for ways to improve the total image quality of their products. One of the elements that affects image quality is the ability to consistently produce the same quality image output on a printer from one day to another, from one week to the next, month after month. Users have become accustomed to printers and copiers that produce high quality color and gray-scaled output. Users now expect to be able to reproduce a color image with consistent quality on any compatible marking device, including another device within an organization, a device at home or a device used anywhere else in the world. There has been a long felt commercial need for efficiently maintaining print color predictability, particularly as electronic marketing has placed more importance on the accurate representation of merchandise in illustrative print or display media.

Description of color, color perception and psychological and physiological phenomena involving light, object and observer, including color measurements using spectrophotometers are described in R. W. G. Hunt, “The Reproduction of Color in Photography, Printing and Television”. Fourth Edition, Fountain Press, Tolworth, England 1987 ISBN 0-8524-2356.

The functional models presented in this specification use a device independent color space to consistently track a set of target colors. L*, a*, b* are the CIE (Commission Internationale de L'éclairage) color standards utilized in the modeling. L* defines lightness, a* corresponds to the red/green value and b* denotes the amount of yellow/blue, which corresponds to the way people perceive color. A neutral color is a color where a*=b*=0.

An important first step in maintaining color and other parameter accuracy and consistency is accuracy in the acquired image data from a data input scanning system. Digital color scanners and copiers provide different image processing settings (“custom parameters”) like brightness, contrast, sharpness, hue shift, and saturation adjust controls that change the appearance of the originals. Typically these controls are provided as a slider bar, which allow the user to move a few positions in either the positive or negative direction (indicating increasing the effect or decreasing the effect of that control.) Such slider-based adjustment techniques are often difficult for the inexperienced and unskilled system operator to use. One problem with the technique is that these positions or levels are fixed and the user does not have any means to change it unless they request a new release of software with the appropriate changes. This is quite cumbersome to accommodate all the combination of changes. In some known scanners, there is a provision for users to enter a custom value, but often that is not easy to ascertain what value would produce the desired result.

Using hue shift as an example of custom parameter adjustment may clarify the subject problems. The hue shift or hue rotation feature allows the user to change uniformly the color of a scanned image to better reproduce the original. If background or certain other areas of the original are slightly off-color, then an appropriate hue shift could be applied to get the desired appearance in the output. Current digital scanners and copiers provide a few levels for hue shift. They are usually labeled in terms of hue angle shifts (−60°, 0°, +60°, etc.) or qualitative labels like reddish, bluish, greenish, etc. Sometimes they are provided with more vague controls like warm, cool, vivid, etc. An average and usually unsophisticated user cannot make a guess at the desired setting from these levels that he/she needs to get the desired result. Since these hue shift settings are prefixed, one often cannot get the exact shift angle that is needed to get the expected result. The general workflow for this feature is that usually the user first previews the original in an editing window. Then he/she determines if the color of the previewed image matches the original. Typically, the background or some more familiar photographic area is what needs to be adjusted. The user makes one of the prefixed hue shift selections, which may or may not produce the desired result. The general direction of hue shifting might be correct but the amount of shifting (or angle of rotation) might not be accurate. Repeated trial and error implementation by the user is frustrating, time consuming and inefficient.

There is a substantial need for a scanning system which can more accurately, efficiently and automatically provide the user desired digital image data.

### BRIEF SUMMARY OF THE INVENTION

A method for adjusting a custom parameter of the scanned imaging includes scanning the image for generating an initial preview image data; selecting a portion of the preview image data having a tendency toward a selective parameter; identifying a difference between the portion and the preselected parameter and selectively adjusting the preview image data by the difference for matching the portion with the preselected parameter.

Selecting a portion of the preview image data can include determining the portion to comprise a recognizable feature of the initial preview image data. Such a recognizable feature may comprise background, skin tone, saturated colors or text print. Alternatively, the selecting may comprise the user designating the portion of the image such as with a positionable window or cursor pointer. The scanned image is displayed to the user in conformance with the initial preview image data in a preview window.

The identifying of the difference between the portion and the preselected parameter comprises displaying a suggested parameter value for the portion to the user, typically in concert with the display of the scanned image with the initial preview image data. The user may accept the suggested parameter in which case the selectively adjusting preview image data will be adjusted in accordance with the suggested parameter in a subsequent scan. At the time of the subsequent scan, the image is displayed in accordance with adjusted scanned image data again allowing the user to verify the accuracy of the scanned image data.

An image scanning system for presenting a user with a suggested parameter adjustment to a scanned image upon system analysis of corresponding scanned image data includes a scanner for generating initial preview image data of the scanned image; a display for displaying the image to the user from the initial preview image data; a processor for detecting a selected portion of the preview image data as having a likelihood of being a standard parameter and for determining a suggested adjustment to the initial preview image data for displaying the selected portion as the standard parameter within the displayed image; a means for communicating the suggested adjustment to the user; and, a means for the user to implement or override the suggested adjustment in a subsequent scan of the image, whereby the user may obtain desired image data from the subsequent scan and the suggested adjustment.

The suggested parameter adjustment may comprise image processing settings including brightness, contrast, sharpness, hue shift or saturation. The suggested parameter adjustment may be user selectable from the image process settings.

The processor may include a histogram detection algorithm or segmentation algorithm for the detecting of the selected portion. Alternatively, the processor may accept a user picked color area or window area of the image as the selected portion.

It is a principal advantage of the subject invention that the scanned image data can be corrected to provide more accurate scanned image data, not only upon a basis of system analysis, but also through user supervisory approval. The provision of suggested parameter adjustment, generally towards a standard parameter setting, provides efficient adjustment more easily implemented by relatively unsophisticated scanning system users who can reliably determine a need for adjustment in the scanned image data, but are uncomfortable with manual adjustment so that the system suggested adjustment can provide enhanced user comfort and confidence in the final and accepted scanned image data.

Other advantages and benefits of the present invention will become apparent to those of ordinary skill in the art upon a reading and understanding of the following detailed description of the preferred embodiments.

### BRIEF DESCRIPTION OF THE DRAWINGS

FIG. 1 is a diagram illustrating components of a conventional digital scanner;

FIG. 2 is a block diagram illustrating the electronic architecture of a digital scanner coupled to a work station, network, storage medium, and image output terminal in accordance with embodiments of the present invention;

FIG. 3 is a representation of an image displayed to a user in an editing window of the system of FIG. 2, and further illustrating a parameter adjustment suggestion based upon the system perception of the image in the window;

FIG. 4 illustrates a color space or a color within a selected region of FIG. 3 is located within the color space and a standard color associated with the selected region of FIG. 3 is also located within the color space;

FIG. 5 illustrates the color space of FIG. 4 wherein selected colors from the image of FIG. 3 are plotted.

FIG. 6 is a flowchart summarizing a method for determination of custom parameters based upon scanned image data in the system of FIG. 2.

### DESCRIPTION OF THE PREFERRED EMBODIMENTS

While the present invention will hereinafter be described in connection with a preferred embodiment thereof, it will be understood that it is not intended to limit the invention to that embodiment. On the contrary, it is intended to cover all alternatives, modifications and equivalents as may be included within the spirit and scope of the invention as defined in the appended claims.

The present invention addresses the need for fast, user friendly, high quality digital scanners, capable of being connected to a wide array of copiers, printers, computers, networks, facsimile machines, etc., and capable of scanning and producing complex and interesting images to be stored, printed or displayed. The images may include text, graphics, photographs and scanned or computer-generated images. Therefore, the present invention is directed toward a user-friendly digital scanner capable of quickly acquiring, processing, storing and outputting digital images of documents.

In order to accomplish this task, the present invention provides an operator (user) with the capability of downloading different image processing parameters from a workstation (e.g. personal computer). The image processing parameters include: image output terminal (IOT) printer profile; overall system tonal reproduction curve (TRC); halftone screens; enhancement and descreening filters; and JPEG quanitization tables. The advantage of providing such flexibility to the user is to avoid many different versions of the software releases for different users. In prior art scanner software, the user needs to express their interest in using different image processing parameters, and then a new software release has to be developed with the inclusion of the new set of image processing parameters. Therefore, there is a problem in maintaining the different versions of software for different users because all users do not want the same set of image processing parameters. By providing a mechanism to download their own image processing parameters, the software can be maintained in a much more manageable fashion, and the user does not have to search through image processing parameters that the user does not require. Instead, once a user creates a data file containing the parameters in the specified fashion, the graphical user interface of the workstation automatically displays the new image processing parameters using a pull down menu list.

For a general understanding of the present invention, reference is made to the drawings. In the drawings and in the specification, like reference numerals have been used throughout to designate identical or equivalent elements or steps.

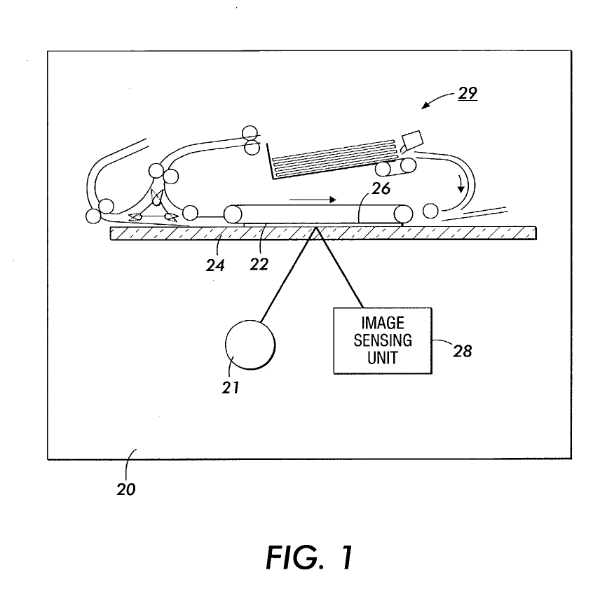

FIG. 1 illustrates components of a scanning unit 20 in a digital scanner. In the scanning unit 20, a light source 21 is used to illuminate a document 22 to be scanned. In a platen type-scanning situation, the document 22 usually rests upon a glass platen 24 which supports the document 22 for scanning purposes. The document may be placed on the glass platen 24 by an operator user. Alternatively, the scanning unit 20 may include a feeder or document handler 29, which places the document on the glass platen 24. Another example of a feeder is shown in U.S. Pat. No. 5,430,536.

On top of the glass platen 24 and the document 22, a backdrop portion (platen cover) 26 is placed so as to prevent stray light from leaving the scanning area and to provide a background from which an input document can be distinguished. The backdrop portion 26 is part of document handler 29. The backdrop portion 26 is the surface or surfaces that can be scanned by an image-sensing unit 28 when a document is or is not present in the scanning station. The light reflected from the document passes through a lens subsystem (not shown) so that the reflected light impinges upon an image sensing unit 28, such as a charged coupled device (CCD) array or a full width array. An example of a full width array is found in U.S. Pat. No. 5,473,513. U.S. Pat. Nos. 5,748,344; 5,552,828; 5,691,760; 5,031,032; 5,545,913; and 5,604,362 provide examples of different full width arrays. A full width array typically comprises one or more linear arrays of photosites, wherein each linear array may be sensitive to one or more colors. In a full color digital scanner, the linear arrays of photosites are used to produce electrical signals which are converted to color image data representing the document that is being scanned. However, in a black/white scanner, preferably only one linear array of photosites is utilized to produce electrical signals which are converted to the black and white image data representing the image of the document, which was scanned.

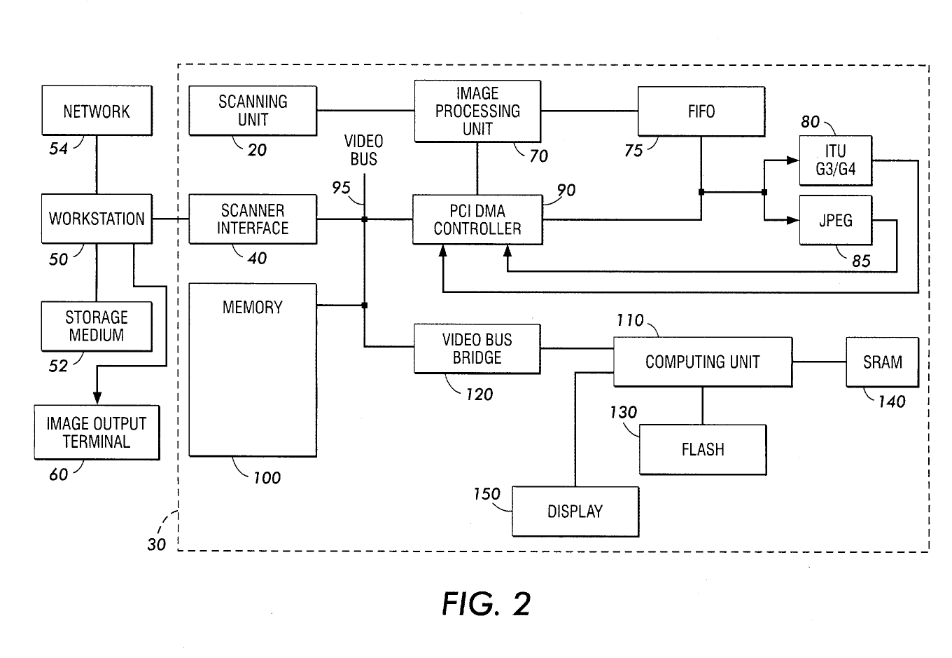

FIG. 2 is a block diagram illustrating the electronic architecture of a digital scanner 30 including the scanning unit 20. The digital scanner 30 is coupled to a workstation 50 by way of a scanner interface 40. An example of a scanner interface 40 is an SCSI interface. Examples of the workstation 50 include a personal computer and a computer terminal. The workstation 50 includes and/or accesses a storage medium 52. The workstation 50 is preferably adapted to communicate with a computer network 54, and to communicate with the Internet either directly or through the computer network 54. The digital scanner 30 is preferably coupled to at least one image output terminal (IOT) 60, such as a printing copier system.

The scanning unit 20 scans an image and converts the analog signals received by the image sensing unit 28 into digital signals (digital data). An image processing unit 70 registers each image, and preferably executes signal correction to enhance the digital signals. As the image processing unit 70 continuously processes the digital signals, the FIFO (first in first out buffer) 75 temporarily stores the digital data outputted by the image processing unit 70, and transmits the digital data to the International Telecommunications Union (ITU) G3/G4 80 and Joint Photographic Experts Group (JPEG) 85 in bursts, so that the processed digital data is compressed. Other data compression units may be substituted for ITU G3/G4 80 and JPEG 85. The compressed digital data is stored in memory 100 preferably by way of Peripheral Component Interconnect Direct Memory Access (PCI DMA) Controller 90 and video bus 95. Alternatively, an operator may not wish to compress the digital data. The operator may bypass the compression step so that the digital data processed by the image processing unit 70 is sent through the FIFO 75 and directly stored in memory 100 by way of PCI DMA Controller 90.

A computing unit 110, such as a microprocessor, is coupled to the scanner interface 40, memory 100 and PCI DMA Controller 90 by way of the video bus 95 and video bus bridge 120. The computing unit 110 is also coupled to a FLASH 130, static RAM 140, and display 150 including an editing/preview window for displaying a representation of the scanned image from the detected digital data. It is a feature of the subject invention that the display will also include a parameter suggested adjustment display area (“suggestion box”), as will be described more in detail hereafter. The computing unit 110 is also connected to the scanning unit 20 and the image processing unit 70 by way of a control/data bus. For example, the computing unit 110 may be communicating with the image processing unit 70 through the video bus 95 and/or PCI DMA Controller 90. Alternatively, the computing unit 110 may communicate directly with different components such as the image processing unit 70 by way of control/data bus(es) (not shown).

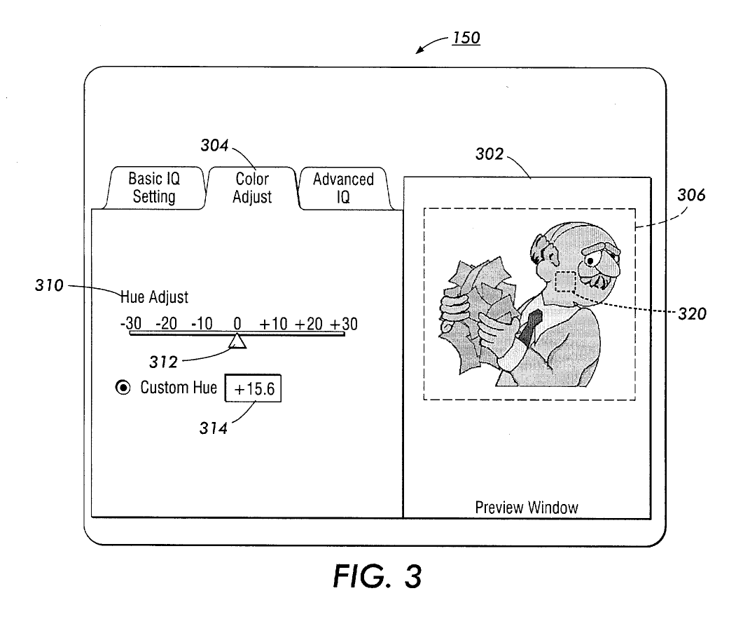

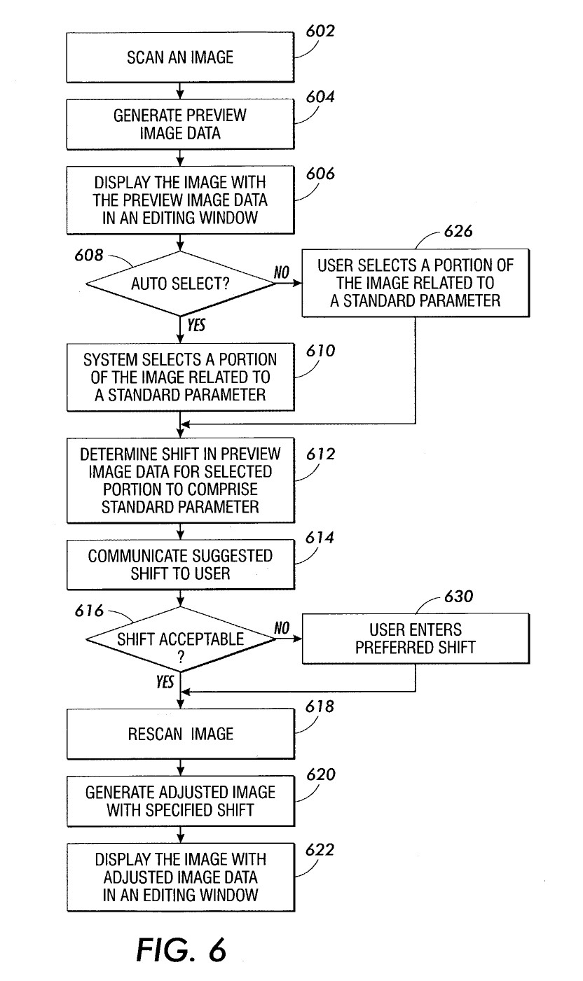

The subject invention provides a suggestion to a user of a scanning device of an “intelligent” adjustment for any of several possible parameter settings. While scanning the image initially for preview, system analysis is done to the image to determine possible optimum settings that are expected to yield more accurate or desired results. The determined optimum setting is concurrently displayed in an associated custom dialog box to the displayed image. The user can accept or override the suggestion based upon his/her perception of the image. For example, in the case of hue shift, the background hue of the original image being scanned into the system is detected and the exact hue angle shift that would yield the expected output, e.g., a “standard” color, typically a white background for graphical image, would be determined and displayed to the user as a suggested adjustment. With this added system help, in most cases users may obtain their desired output in a single scan. With particular reference to FIG. 3, the display 150 is seen as user interface comprising a preview editing window 302 and a parameter setting box 314 to illustrate how a user would be able to benefit from the subject invention. Reference will also be made to the steps identified in the flowchart of FIG. 6 in accordance with the method of practicing the subject invention.

As an input image is first scanned 602 for preview, initial preview digital data is generated 604 which data is processed by the computing unit 110 for producing 606 an image display 306 within the preview window 302. Of course, the scanned image can comprise any of a number of things, e.g., photograph, printed brochure, a bar graph or artistic drawn image such as is actually shown in the window 306 of FIG. 3. The preview image is comprised of a number of standard image parameters. As noted above, brightness, contrast, sharpness, hue shift, or saturation, are such parameters and all of which are adjustable to control the appearance of the original as seen in the display 150 or image output terminal 60. It is within the intended scope of the invention that adjustment of any of these parameters can be automatically implemented per the inventive steps, but for purposes of simplification of description of the invention, the present detailed description will use merely a “hue shift” as an operating example. A hue shift or hue rotation feature allows a user to change uniformly the color of the scanned image to better or more accurately reproduce the originally scanned document. Determination of inaccurate hue generally tends to affect the image all in one color vector direction. Accordingly, a correction of hue to a predetermined standard feature or color will generally more accurately shift the hue for all other colors in the image. There are many areas of an image that may have a tendency towards a predetermined standard color or other parameter. For example, the background of a brochure or artistic drawing of the kind shown in FIG. 3 is usually white. Standard white would be predetermined to be the nearest predominate primary color. Accordingly, if the initial preview image data is represented by an image 306 in the preview window 302 that is slightly off color, than an appropriate hue shift for this “off” color can be applied to the whole image to get the desired appearance. Current digital scanners and copiers provide a few levels for hue shift. They are usually labeled in terms of hue shift angles (−60°, 0°, +60°, etc.) or qualitative labels like reddish, bluish, greenish, etc. Sometimes they are provided with more vague controls like warm, cool, vivid, etc. The general workflow for this feature is that usually the user first previews the original in an editing window, then he/she determines if the color of the previewed image matches the original. Typically, the background or some photographic area is what is most easily recognizable as what is needed to be adjusted. The user may try one of the prefixed hue shift selections, but as noted above, though the general direction of hue shifting might be correct but the amount of shifting (or angle of rotation) might not be accurate. In the interface 304 of FIG. 3, the hue adjust slider bar 310 shows an available range of hue settings with arrowhead 312 showing the position of system setting prior to adjustment.

The system automatic parameter adjustment is via several modes of operation selectable 608 by the user. In the first mode, the system selects 610 a recognizable portion of the image related to a standard parameter. For example, a background area 312 of the image 306. A background area would be identified by standard histogram background detection algorithms or segmentation algorithms embedded within the scanning system 30 for effectively selecting the portion of the preview image data having a tendency towards a preselected parameter, e.g., primary white as being the nearest standard predominant primary background color. Other colors of course may be so recognized as being ones that are commonly observed on a regular basis. Black, sky blue, apple red and skin tones are typical examples. The difference between the selected portion of the previous image data and the predetermined standard parameter must be identified so that a shift can be determined 612 for the preview image data for the selected portion to comprise the standard parameter. For example, shifting an off white background to a pure white background. The interface 304 comprising the suggestion box 314 exemplifies how the suggested shift can be communicated 614 to a user. As noted above, the system performs image analysis on the preview image data for identifying a selected portion of the preview image having a tendency towards a suggested parameter value. Continuing with the hue example, as the input images are first scanned for preview, the hue of the background is determined. Based on the hue detected, the closest “standard” color is identified. Although the background colors could be a variety of different standard colors, such as red, green, blue, cyan, magenta, yellow, black, white, orange, pink, to name a few, the predetermined list could be as big as possible for any particular system. After the determination of the closest “standard” color, in this case, primary white, the hue angle difference is computed as suggested to the user via the custom view adjust dialog box 314. The user still has the flexibility of accepting or rejecting one of either the prefix hue setting of the suggested shift, or any manually specified custom hue angle. In the suggestion box of FIG. 3, it is suggested that a +15.6° shift would yield a standard primary “white” background. If the user accepts 616, this shift is implemented in a rescan 618 and second preview image data can be generated 620 with the specified shift so that the image can be redisplayed 622 with the adjusted image data in the editing window 302. The user can view the suggested shift as acceptable and conclude the scanning process, or can continue to shift other parameters until an acceptable result is obtained. However, the system suggestion of a custom parameter shift provides improved efficiencies in obtaining accurate scanned image data by avoiding a requirement for the user to manually enter a subjectively determined hue shift value.

With continued references to FIGS. 3 and 6, alternative implementations of the invention are described. First, manually windowing the image as an alternative application of the invention is described. In this alternative embodiment, a manual window 320 is applied to a selected portion of the image displayed from the preview image data. The user selection 620 of a selected portion of the image is an alternative to the system automatically selecting 608, 610 a segmented portion. The application of the window is performed through conventional windowing techniques such as by brush, pointer or cursor (not shown) designation. As noted above, the system commonly recognizable features generally comprise background, skin tone, saturated colors or text print. The user designated window is analyzed for these kinds of features and then suggested parameter adjustment proceeds as above for the image portion comprising the window. It is expected that the user designated window will include a represented color that is commonly observed and recognized by most people. For example, if the manual window 320 were applied as shown to a skin tone portion,. system operation will then continue just as in the purely automatic embodiment wherein a difference is identified between the skin tone portion 320 and a preselected standard skin tone parameter. A hue adjustment is suggested in the box 314 and upon rescanning 618 the suggested adjustment will be implemented unless the user rejects the proposed adjustment and enters a 630 alternative preferred shift. It is within the scope of the invention that different areas of the image may be designated by manually drawn windows and system programming of different image processing settings for each window can be suggested. It is also within the scope of the invention that such system adjustments can be implemented, most likely through software, contemporaneously with the acceptance of the suggested adjustment in a parameter setting (and therefore without need for rescanning of the image.)

Yet another alternative embodiment of the invention comprises a scanner that could provide a user color picker feature. In this embodiment the user will be able to select any particular area in the scanned image and determine the color of that area (or pixel). Similar to the automatic background hue adjust, the closest “standard” color to the color of that pixel is determined and the appropriate hue adjusted value displayed in the custom hue adjust dialog box 314. Use of a color picker allows the user to pick any area in the input image for which he/she wants to adjust the hue. For example, a poor original photograph might have some “off colors” in the scanned image, which the user can correct for by using the hue adjust feature of the scanner. The color picker featured is slightly different from the manual windowing feature in that the parameter adjustment for the manual windowing is limited to the selected window, while for the color picker feature the suggested adjustment is applicable to the entire image.

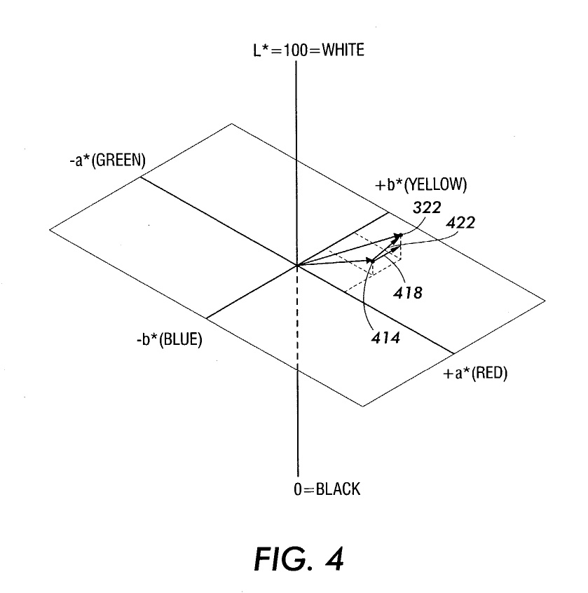

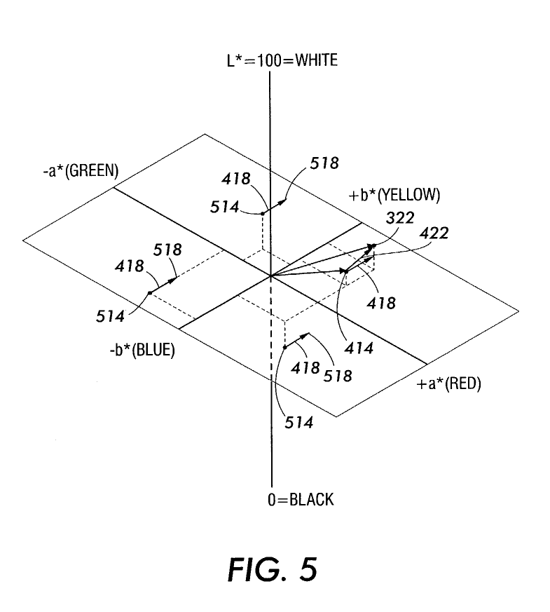

With reference to FIGS. 4 and 5, assuming that the manual window or color picker window 320 is applied to a skin tone that has a slightly bluish cast, the suggested shift in hue to a common parameter skin tone value can be illustrated. Referring to FIG. 4, it is assumed that the input image data for the window 320 includes a blue cast, the average color 414 of the pixels in the selected region 320 has a lower or more negative b* value than the suggested standard primary color 322. Additionally, as illustrated in the example of FIG. 4, the standard color 322 is lighter or more white than the average value 414 of the pixels of the selected region 320. Therefore, the standard color 322 has a higher L* value.

The image-processing computing unit 110 compares the average color value of the pixels of the selected region 320 to the suggested color 322. For example, the image-processing unit 110 calculates or determines a chrominance difference, error, or comparison vector 418. The chrominance comparison vector 418 is defined by differences in the a* and/or b* values of the average color vector 414 of the pixels in the selected region 320 and the suggested color 322. A total difference, error, or comparison vector 422 is defined by differences in the L*, a* b* values of the average color 414 of the pixels in the selected region 320 and the suggested color 322.

When correcting the hue of an image, it is often preferable to adjust only the chrominance of the image. For example, when an object in an image is associated with a neutral standard color, it is usually desirable to preserve the luminance of the object and shift only the chrominance. Therefore, it is usually preferable to use the chrominance comparison vector 418 when adjusting or shifting the color values of the pixels of the image and disregard the total difference, error, or comparison vector 422.

For example, referring to FIG. 5, colors 514 of pixels of the image are shifted by an amount and in a direction defined by the chrominance comparison vector 418. The shifting yields corrected colors 518.

The invention has the overall advantage of providing a user a suggestion for a custom parameter adjust and therefore helps the user in obtaining a desired or more accurate output within a single scanning attempt in most cases. The invention provides needs of use to a scanning operator not available with conventional slider bar adjustment techniques.

The invention is described with reference to particular embodiments. Modifications and alterations may occur to others upon reading and understanding the specification.

For example, the functions of the functional block described and referenced in FIG. 2 or the function of the steps described with reference to FIG. 6, can be preformed in different functional blocks and arranged in different organizations. While for the most part, the described embodiment relies on the use of a computer display for communicating with a system operator in order to receive suggested or selectable information, a computer display is not required. For example, selection information can be included on a printed page or described in reference to data glyph representations associated therewith. The printed page can be scanned and used to communicate selective information for the system. It is intended that all such modifications and alterations are included insofar as they come within the scope of the appended claims or the equivalents thereof.

What is claimed:

1. A method for adjusting a custom parameter of a scanned image comprising:
scanning the image for generating initial preview image data;
selecting a portion of the preview image data having a tendency towards a preselected parameter;
identifying a difference between the portion and the preselected parameter; and,
selectively adjusting the preview image data by the difference for matching the portion with the preselected parameter.

2. The method as defined in claim 1 wherein the selecting comprises determining the portion to comprise a recognizable feature of the initial preview image data.

3. The method as defined in claim 2 wherein the recognizable feature comprises one of background, skin tone, saturated colors or text print.

4. The method as defined in claim 1 wherein the selecting comprises a user designating the portion.

5. The method as defined in claim 4 wherein the designating comprises displaying the scanned image to the user in conformance with the initial preview image data.

6. The method as defined in claim 5 wherein the identifying comprises displaying a suggested parameter value for the portion.

7. The method as defined in claim 6 wherein the selectively adjusting comprises the user accepting the suggested parameter value.

8. The method as defined in claim 7 further comprising a second scanning of the image for generating second preview image data and second displaying the second scanned image wherein the portion comprises the suggested parameter value.

9. An image scanning system for presenting a user with a suggested parameter adjustment to a scanned image upon system analysis of corresponding scanned image data, comprising:
a scanner for generating initial preview image data of the scanned image;
a display for displaying the image to the user from the initial preview image data;
a processor for detecting a selected portion of the preview image data as having a likelihood of being a standard parameter and for determining a suggested adjustment to the initial preview image data for displaying the selected portion as the standard parameter within the displayed image;
a means for communicating the suggested adjustment to the user; and,
a means for the user to implement or override the suggested adjustment in a subsequent scan of the image, whereby the user may obtain desired image data from the subsequent scan and the suggested adjustment.

10. The scanning system of claim 9 further comprising a printer.

11. The scanning system of claim 9 further comprising a xerographic copier.

12. The scanning system of claim 9 wherein the suggested parameter adjustment comprises image process settings including brightness, contrast, sharpness, hue shift or saturation.

13. The scanning system of claim 12 wherein the suggested parameter adjustment is user selectable from the image process settings.

14. The scanning system of claim 9 wherein the processor includes a histogram detection algorithm or segmentation algorithm for the detecting of the selected portion.

15. The scanning system of claim 14 wherein the selected portion comprises a background area of an illustrative drawing or a photographic image, a saturated color area of a bar graph, a print area of a textual document, or a skin tone area of the illustrative drawing or photographic image.

16. The scanning system of claim 9 wherein the processor accepts a user picked color area as the selected portion.

17. The scanning system of claim 16 further including a means for designating by the user on the display the user picked color area.

18. The scanning system of claim 9 wherein the subsequent scan comprises adjusted image data and the display displays an adjusted image comprising the desired image data acquired from the subsequent scan and adjusted image data.

19. The scanning system of claim 9 that the suggested adjustment is implemented by a manual window portion of the initial preview image data.
